(19) United States
(12) Patent Application Publication
(10) Pub. No.: US 2023/0118588 A1
(43) Pub. Date: Apr. 20, 2023

(54) SENSOR ARRANGEMENT WITH GROUND LAYER

(71) Applicant: Tactual Labs Co., New York, NY (US)

(72) Inventor: BRAON MOSELEY, Round Rock, TX (US)

(73) Assignee: Tactual Labs Co., New York, NY (US)

(21) Appl. No.: 17/914,433

(22) PCT Filed: Mar. 25, 2021
(86) PCT No.: PCT/US21/24247

§ 371 Date: Sep. 26, 2022

Related U.S. Application Data
(60) Provisional application No. 63/000,453, filed on Mar. 26, 2020.

(51) Int. Cl. G06F 3/044; B60N 2/00; B60N 2/58; G06F 3/041

(52) U.S. Cl. CPC G06F 3/0448; B60N 2/002; B60N 2/58; G06F 3/0418

(57) ABSTRACT

A seat system has a seat cover and at least one transmitting antenna and at least one receiving antenna. Additionally, located within the system is a transmitting antenna transmitting a signal that is 180 degrees out of phase with respect to the signal transmitted from the other at least one transmitting antenna. The signal that is 180 degrees out of phase can alter measurements of signals received by the receiving antenna. There can also be a source of ground located within the seat system that is able to alter measurements of signals received by the receiving antenna.

This Application claims the benefit of U.S. Provisional Application Ser. No. 63/000,453 filed Mar. 26, 2020, the contents of which are incorporated herein by reference. This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The disclosed systems and methods relate in general to the field of sensing, and in particular to sensor arrangements implementing ground layers.

### BRIEF DESCRIPTION OF THE DRAWINGS

The foregoing and other objects, features, and advantages of the disclosure will be apparent from the following more particular description of embodiments as illustrated in the accompanying drawings in which reference characters refer to the same parts throughout the various views. The drawings are not necessarily to scale, emphasis instead being placed upon illustrating principles of the disclosed embodiments.

FIG. 1 is a cross-sectional diagram showing a seat system.

FIG. 2 is a cross-sectional diagram of a seat system.

FIG. 3 is a cross-sectional diagram of a seat system.

FIG. 4 is a cross-sectional diagram of a seat system having multiple sensor arrangements.

### DETAILED DESCRIPTION

The present application contemplates an improved sensing device implementing fast multi-touch sensing (FMT) chips. FMT chips are suited for use with frequency orthogonal signaling techniques (see, e.g., U.S. Pat. Nos. 9,019,224 and 9,529,476, and 9,811,214, all of which are hereby incorporated herein by reference). The sensor configurations discussed herein may be used with other signal techniques including scanning or time division techniques, and/or code division techniques. It is pertinent to note that the sensors described and illustrated herein are also suitable for use in connection with signal infusion (also referred to as signal injection) techniques and apparatuses.

The presently disclosed systems and methods involve principles related to and for designing, manufacturing and using capacitive based sensors, and particularly capacitive based sensors that employ a multiplexing scheme based on orthogonal signaling such as but not limited to frequency-division multiplexing (FDM), code-division multiplexing (CDM), or a hybrid modulation technique that combines both FDM and CDM methods. References to frequency herein could also refer to other orthogonal signal bases. As such, this application incorporates by reference Applicants' prior U.S. Pat. No. 9,019,224, entitled “Low-Latency Touch Sensitive Device” and U.S. Pat. No. 9,158,411 entitled “Fast Multi-Touch Post Processing.” These applications contemplate FDM, CDM, or FDM/CDM hybrid touch sensors which may be used in connection with the presently disclosed sensors. In such sensors, interactions are sensed when a signal from a row conductor is coupled (increased) or decoupled (decreased) to a column conductor and the result received on that column conductor. By sequentially exciting the row conductors and measuring the coupling of the excitation signal at the column conductors, a heatmap reflecting capacitance changes, and thus proximity, can be created.

This application also employs principles used in fast multi-touch sensors and other interfaces disclosed in the following: U.S. Pat. Nos. 9,933,880; 9,019,224; 9,811,214; 9,804,721; 9,710,113; and 9,158,411. Familiarity with the disclosure, concepts and nomenclature within these patents is presumed. The entire disclosures of those patents and the applications incorporated therein by reference are incorporated herein by reference. This application also employs principles used in fast multi-touch sensors and other interfaces disclosed in the following: U.S. patent applications Ser. Nos. 15/162,240; 15/690,234; 15/195,675; 15/200,642; 15/821,677; 15/904,953; 15/905,465; 15/943,221; 62/540,458, 62/575,005, 62/621,117, 62/619,656 and PCT publication PCT/US2017/050547, familiarity with the disclosures, concepts and nomenclature therein is presumed. The entire disclosure of those applications and the applications incorporated therein by reference are incorporated herein by reference.

As used herein, and especially within the claims, ordinal terms such as first and second are not intended, in and of themselves, to imply sequence, time or uniqueness, but rather, are used to distinguish one claimed construct from another. In some uses where the context dictates, these terms may imply that the first and second are unique. For example, where an event occurs at a first time, and another event occurs at a second time, there is no intended implication that the first time occurs before the second time, after the second time or simultaneously with the second time. However, where the further limitation that the second time is after the first time is presented in the claim, the context would require reading the first time and the second time to be unique times. Similarly, where the context so dictates or permits, ordinal terms are intended to be broadly construed so that the two identified claim constructs can be of the same characteristic or of different characteristics. Thus, for example, a first and a second frequency, absent further limitation, could be the same frequency, e.g., the first frequency being 10 Mhz and the second frequency being 10 Mhz; or could be different frequencies, e.g., the first frequency being 10 Mhz and the second frequency being 11 Mhz. Context may dictate otherwise, for example, where a first and a second frequency are further limited to being frequency orthogonal to each other, in which case, they could not be the same frequency.

Throughout this disclosure, the terms “touch”, “touches”, “touch event”, “contact”, “contacts”, “hover”, or “hovers”, “gesture”, “pose” or other descriptors may be used to describe events or periods of time in which a user's finger, a stylus, an object, or a body part is detected by a sensor. In some sensors, detections occur only when the user is in physical contact with a sensor, or a device in which it is embodied. In some embodiments, and as generally denoted by the word “contact”, these detections occur as a result of physical contact with a sensor, or a device in which it is embodied. In other embodiments, and as sometimes generally referred to by the terms “hover”, “gesture” or “pose” the sensor may be tuned to allow for the detection of “touch events” that are at a distance above the touch surface or otherwise separated from the sensor device and causes a recognizable change, despite the fact that the conductive or capacitive object, e.g., a stylus or pen, is not in actual physical contact with the surface. Therefore, the use of language within this description that implies reliance upon sensed physical contact should not be taken to mean that the techniques described apply only to those embodiments; indeed, nearly all, if not all, of what is described herein would apply equally to “contact”, “hover”, “pose” and “gesture” each of which is a touch or touch event. Generally, as used herein, the word “hover” refers to non-contact touch events or touch, and as used herein the terms “hover”, “pose” and “gesture” are types of “touch” in the sense that “touch” is intended herein. Thus, as used herein, the phrase “touch event” and the word “touch” when used as a noun include a near touch and a near touch event, or any other gesture that can be identified using a sensor. “Pressure” refers to the force per unit area exerted by a user contact (e.g., presses by their fingers or hand) against the surface of an object. The amount of “pressure” is similarly a measure of “contact”, i.e., “touch”. “Touch” refers to the states of “hover”, “contact”, “gesture”, “pose”, “pressure”, or “grip”, whereas a lack of “touch” is generally identified by signals being below a threshold for accurate measurement by the sensor. In accordance with an embodiment, touch events may be detected, processed, and supplied to downstream computational processes with very low latency, e.g., on the order of ten milliseconds or less, or on the order of less than one millisecond.

Certain principles of a fast multi-touch (FMT) sensor have been disclosed in the patent applications discussed above. Orthogonal signals are transmitted into a plurality of transmitting conductors (or antennas) and the information received by receivers attached to a plurality of receiving conductors (or antennas), the signal is then analyzed by a signal processor to identify touch events. The transmitting conductors and receiving conductors may be organized in a variety of configurations, including, e.g., a matrix where the crossing points form nodes, and interactions are detected at those nodes by processing of the received signals. In an embodiment where the orthogonal signals are frequency orthogonal, spacing between the orthogonal frequencies, Δf, is at least the reciprocal of the measurement period τ, the measurement period τ being equal to the period during which the columns are sampled. Thus, in an embodiment, a column or antenna may be measured for one millisecond (τ) using frequency spacing (Δf) of one kilohertz (i.e., Δf=1/τ).

In an embodiment, the signal processor of a mixed signal integrated circuit (or a downstream component or software) is adapted to determine at least one value representing each frequency orthogonal signal transmitted to a row. In an embodiment, the signal processor of the mixed signal integrated circuit (or a downstream component or software) performs a Fourier transform on the received signals. In an embodiment, the mixed signal integrated circuit is adapted to digitize received signals. In an embodiment, the mixed signal integrated circuit (or a downstream component or software) is adapted to digitize received signals and perform a discrete Fourier transform (DFT) on the digitized information. In an embodiment, the mixed signal integrated circuit (or a downstream component or software) is adapted to digitize received signals and perform a Fast Fourier transform (FFT) on the digitized information—an FFT being one type of discrete Fourier transform.

It will be apparent to a person of skill in the art in view of this disclosure that a DFT, in essence, treats the sequence of digital samples (e.g., windows) taken during a sampling period (e.g., integration period) as though it repeats. As a consequence, signals that are not center frequencies (i.e., not integer multiples of the reciprocal of the integration period (which reciprocal defines the minimum frequency spacing)), may have relatively nominal, but unintended consequence of contributing small values into other DFT bins. Thus, it will also be apparent to a person of skill in the art in view of this disclosure that the term orthogonal as used herein is not “violated” by such small contributions. In other words, as we use the term frequency orthogonal herein, two signals are considered frequency orthogonal if substantially all of the contribution of one signal to the DFT bins is made to different DFT bins than substantially all of the contribution of the other signal.

In an embodiment, received signals are sampled at at least 1 MHz. In an embodiment, received signals are sampled at at least 2 MHz. In an embodiment, received signals are sampled at 4 Mhz. In an embodiment, received signals are sampled at 4.096 Mhz. In an embodiment, received signals are sampled at more than 4 MHz. To achieve kHz sampling, for example, 4096 samples may be taken at 4.096 MHz. In such an embodiment, the integration period is 1 millisecond, which per the constraint that the frequency spacing should be greater than or equal to the reciprocal of the integration period provides a minimum frequency spacing of 1 KHz. (It will be apparent to one of skill in the art in view of this disclosure that taking 4096 samples at 4 MHz would yield an integration period slightly longer than a millisecond, and not achieve 1 kHz sampling, and a minimum frequency spacing of 976.5625 Hz.) In an embodiment, the frequency spacing is equal to the reciprocal of the integration period. In such an embodiment, the maximum frequency of a frequency orthogonal signal range should be less than 2 MHz. In such an embodiment, the practical maximum frequency of a frequency orthogonal signal range is preferably less than about 40% of the sampling rate, or about 1.6 MHz. In an embodiment, a DFT (which could be an FFT) is used to transform the digitized received signals into bins of information, each reflecting the frequency of a frequency orthogonal signal transmitted which may have been transmitted by the transmit antenna 130. In an embodiment 2048 bins correspond to frequencies from 1 KHz to about 2 MHz. It will be apparent to a person of skill in the art in view of this disclosure that these examples are simply that, exemplary. Depending on the needs of a system, and subject to the constraints described above, the sample rate may be increased or decreased, the integration period may be adjusted, the frequency range may be adjusted, etc.

In an embodiment, a DFT (which can be an FFT) output comprises a bin for each frequency orthogonal signal that is transmitted. In an embodiment, each DFT (which can be an FFT) bin comprises an in-phase (I) and quadrature (Q) component. In an embodiment, the sum of the squares of the I and Q components is used as a measure corresponding to signal strength for that bin. In an embodiment, the square root of the sum of the squares of the I and Q components is used as measure corresponding to signal strength for that bin. It will be apparent to a person of skill in the art in view of this disclosure that a measure corresponding to the signal strength for a bin could be used as a measure related to activity, touch events, etc. In other words, the measure corresponding to signal strength in a given bin would change as a result of some activity proximate to the sensors, such as a touch event.

The sensing systems discussed herein use transmitting and receiving antennas (also referred to herein as conductors, row conductors, column conductors, transmitting conductors, receiving conductors). However, it should be understood that whether the transmitting antennas or receiving antennas are functioning as a transmitter of signals, a receiver of signals, or both depends on context and the embodiment. In an embodiment, the transmitters and receivers for all or any combination of the patterns are operatively connected to a single integrated circuit capable of transmitting and receiving the required signals. In an embodiment, the transmitters and receivers are each operatively connected to a different integrated circuit capable of transmitting and receiving the required signals, respectively. In an embodiment, the transmitters and receivers for all or any combination of the patterns may be operatively connected to a group of integrated circuits, each capable of transmitting and receiving the required signals, and together sharing information necessary to such multiple IC configurations. In an embodiment, where the capacity of the integrated circuit (i.e., the number of transmit and receive channels) and the requirements of the patterns (i.e., the number of transmit and receive channels) permit, all of the transmitters and receivers for all of the multiple patterns used by a controller are operated by a common integrated circuit, or by a group of integrated circuits that have communications therebetween. In an embodiment, where the number of transmit or receive channels requires the use of multiple integrated circuits, the information from each circuit is combined in a separate system. In an embodiment, the separate system comprises a GPU and software for signal processing.

In an embodiment, the mixed signal integrated circuit is adapted to generate one or more signals and send the signals to the transmitting antennas via the transmitter. In an embodiment, the mixed signal integrated circuit is adapted to generate a plurality of frequency orthogonal signals and send the plurality of frequency orthogonal signals to the transmitting antennas. In an embodiment, the mixed signal integrated circuit is adapted to generate a plurality of frequency orthogonal signals and one or more of the plurality of frequency orthogonal signals to each of a plurality of transmit antennas. In an embodiment, the frequency orthogonal signals are in the range from DC up to about 2.5 GHz. In an embodiment, the frequency orthogonal signals are in the range from DC up to about 1.6 MHz. In an embodiment, the frequency orthogonal signals are in the range from 50 KHz to 200 KHz. The frequency spacing between the frequency orthogonal signals should be greater than or equal to the reciprocal of the integration period (i.e., the sampling period).

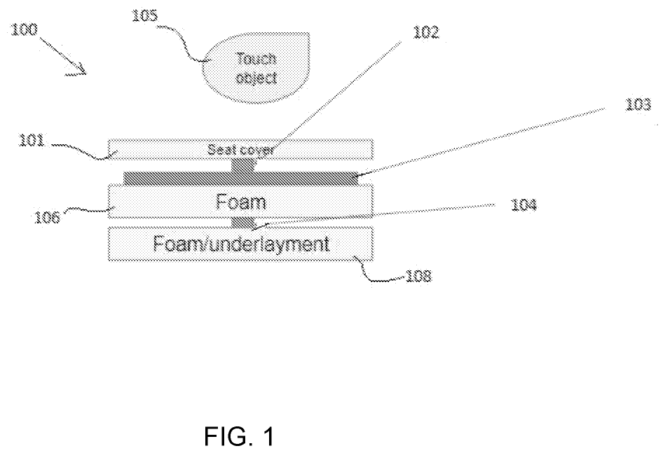

Turning to FIG. 1, shown is a cross-sectional view of an embodiment of a seat system 100. Seat system 100 is generally formed from a seat, or seats, located within a vehicle. In an embodiment, the seat system 100 is located elsewhere, such as a theater or household, office location, etc.

For ease of discussion, the seat system 100 discussed herein is part of a vehicle, such as an automobile, for the purpose of discussion. In an embodiment, the seat system 100 is located within an automobile. In an embodiment, the seat system 100 is located within a truck. In an embodiment, the seat system 100 is located within a plane. In an embodiment, the seat system 100 is located within a train. In an embodiment, the seat system 100 is located within a bus. In an embodiment, the seat system 100 is located within a theater. In an embodiment, the seat system 100 is located within a house.

The seat system 100 comprises a seat cover 101. The seat cover 101 is the portion of the seat system 100 upon which an individual or an object is placed. Located under the seat cover 101 is a transmitting antenna 102, a receiving antenna 103 and at least one other transmitting antenna 104. In an embodiment, the transmitting antenna 102 is coplanar with the seat cover 101 and interwoven with the seat cover 101 or embedded in the seat cover 101. In an embodiment, the receiving antenna 103 is coplanar with the seat cover 101 and interwoven with the seat cover 101 or embedded in the seat cover 101. In an embodiment, both the transmitting antenna 102 and the receiving antenna 103 are coplanar with the seat cover 101 and interwoven with the seat cover 101 or embedded in the seat cover 101.

Since FIG. 1 is a cross-sectional view, the widthwise portion of transmitting antennas 102 and 104 are shown, the lengthwise portions of transmitting antennas 102 and 104 extend into the page. The lengthwise cross-sectional view of the receiving antenna 103 is shown. Further, for ease of description, only one grouping of transmitting antennas 102, 104 and receiving antenna 103 is shown. It should be understood that in some embodiments there are a plurality of transmitting antennas and receiving antennas that are used in forming the seating system.

In the embodiment shown in FIG. 1, transmitting antenna 102 is in a substantially fixed relationship with respect to the receiving antenna 103. That is to say transmitting antenna 102 does not move with respect to the receiving antenna 103. Transmitting antenna 102 and receiving antenna 103 may move as a pair, together, when they move. Transmitting antenna 102 is located proximate to receiving antenna 103 so that interaction with the field lines, established between the transmitting antenna 102 and the receiving antenna 103, enables the detection of touch events by an object 105 via the interaction of the object 105 with the established field lines. Generally the field lines that are generated by the transmitting antenna 102 and the receiving antenna 103 and that provide indication of touch events are referred to herein as “tixels”.

The transmitting antenna 102 and the receiving antenna 103 are located proximate to each other and form a tixel adapted to determine hover and near hover from the presence of the touch object 105. In an embodiment, a touch object 105 is the human that occupies a seat. When there is a plurality of transmitting antennas 102, in an embodiment, a plurality of signals that are orthogonal with respect to each other signal transmitted on the transmitting antennas are transmitted. In an embodiment, a plurality of frequency orthogonal signals are transmitted on each of the antennas.

When the touch object 105 approaches and comes into contact with the seat cover 101, the delta of the signal is changing continuously. The change in the delta of the signal is in the direction, which is to say the change in delta is either increasing continuously during the approach of the touch object 105 or the change in delta is decreasing continuously during the approach of the touch object 105. As the touch object 105 approaches the seat cover 101, the touch delta either increases or decreases depending on the manner in which the interaction is being measured.

When the seat cover 101 is deformable, and as it compresses under pressure, the touch delta changes in a manner that indicates a continuing approach. In an embodiment, the seat cover 101 is typically made from a compressible foam. Preferably the compressible foam is adapted to compress under minimal pressure. In an embodiment, the compressible seat cover 101 is formed from a compressible foam that is adapted to compress under pressure that is less than the pressure needed to compress the internal layer 106. In the embodiment shown in FIG. 1 the internal layer 106 is made from a foam. However, it should be understood that internal layer 106 may be made of any material that is compressible when subjected to weights characteristic of humans. In an embodiment, internal layer 106 may be formed of more than one sublayer of material. In an embodiment, internal layer 106 is formed from more than one type of material.

As the touch object 105 provides more pressure to the seat cover 101, the internal layer 106 that is located between transmitting antenna 102 and transmitting antenna 104 compresses. In the embodiment of FIG. 1, transmitting antenna 104 is transmitting the same frequency as the frequency being transmitted from transmitting antenna 102, however, while the frequency of the signal transmitted from transmitting antenna 104 is the same as the frequency transmitted from the transmitting antenna 102, the signal is transmitted at a phase that is opposite to the phase of the signal transmitted from transmitting antenna 102. In an embodiment, the signal level Vpp is reduced on the transmitting antenna 104, with respect to the signal transmitted from the transmitting antenna 102, in order to provide a higher baseline for the signal establishing delta of the signals.

The substrate layer 108 is preferably made of material that deforms less than the material from which internal layer 106 is made. The deformability of the internal layer 106 with respect to the substrate layer 108 is such that the internal layer 106 deforms more than the substrate layer 108. In an embodiment, the internal layer 106 is made of a first type of foam material that deforms more than a foam material that the substrate layer 108 is made from. In an embodiment, the internal layer 106 is made of a foam that is more deformable than a plastic material from which the substrate layer 108 is made. In an embodiment, the internal layer 106 is made of a foam that is more deformable than a metallic material from which the substrate layer 108 is made. The relationship between the internal layer 106 and the substrate layer 108 is preferably such that substrate layer 108 substantially does not, or at all, deform so that most of the deformation in the seat system occurs at the internal layer 106.

Keeping the signal from transmitting antenna 104 180 degrees out of phase from the signal from transmitting antenna 102, a greater signal delta is caused upon movement of the internal layer 106. Because the signal from transmitting antenna 104 is 180 degrees out of phase from the signal from transmitting antenna 102, the deformation of the internal layer 106 causes a delta in the signal that will amplify changes (deltas) in the signal that is measured when received by the receiving antenna. The amplified changes(i.e. the delta or change in the magnitude of signal received by the receiving antenna 103) enable an enhanced view of deformations caused within and by the seat system 100.

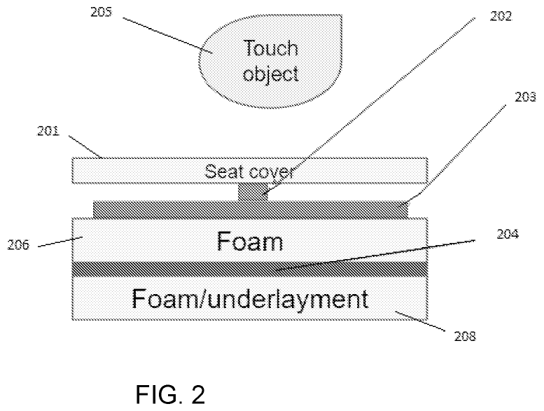

Turning to FIG. 2, shown is a cross-sectional view of an embodiment of a seat system 200. Seat system 200 is generally a seat or a system composed of seats used in the same manner as the seat system 100 discussed above. The functions and uses of seat system 100 are also applicable to the functions and uses of seat system 200. The seat system 200 comprises a seat cover 201. The seat cover 201 is the portion of the seat system 200 upon which an individual or an object is placed. Located under the seat cover 201 is a transmitting antenna 202, a receiving antenna 203 and a grounding layer 204.

In an embodiment, the transmitting antenna 202 is coplanar with the seat cover 201 and interwoven with the seat cover 201. In an embodiment, the receiving antenna 203 is coplanar with the seat cover 201 and interwoven with the seat cover 201 or embedded in the seat cover 201. In an embodiment, both the transmitting antenna 202 and the receiving antenna 203 are coplanar with the seat cover 201 and interwoven with the seat cover 201 or embedded in the seat cover 201.

FIG. 2 is a cross-sectional view of the seat system 200, the widthwise portion of transmitting antenna 202 is shown. It should be understood that the lengthwise portion of transmitting antenna 202 extends into the page. The lengthwise cross-sectional view of the receiving antenna 203 is shown. Further, for ease of description, only one grouping of transmitting antenna 202, grounding layer 204 and receiving antenna 203 is shown. It should be understood that in some embodiments there are a plurality of transmitting antennas and receiving antennas that are used in forming the seating system. For example, the system may be formed as a mesh that comprises a plurality of transmitting antennas, receiving antennas and a ground layer, or more than one component that comprises ground layer components.

In the embodiment shown in FIG. 2, transmitting antenna 202 is in a substantially fixed relationship with respect to the receiving antenna 203. That is to say transmitting antenna 202 does not move with respect to the receiving antenna 203. In the embodiment shown, transmitting antenna 202 and receiving antenna 203 move in a predetermined manner with respect to each other.

Transmitting antenna 202 is located proximate to receiving antenna 203 so that interaction with the field lines enables the detection of touch events by an object 205. The transmitting antenna 202 and the receiving antenna 203 are located proximate to each other. The transmitting antenna 202 and the receiving antenna 203 form a tixel that is formed from the interaction between the transmitting antenna 202 and the receiving antenna 203. The tixel is adapted to pick up hover and near hover from the touch object 205. In an embodiment, the touch object 205 is a human that is to become the occupant in a seat. In an embodiment, the touch object 205 is another living creature. In an embodiment, the touch object 205 is an object other than a human.

In an embodiment, when there is a plurality of transmitting antennas 202, a plurality of signals that are orthogonal with respect to each other signal are transmitted on the transmitting antennas 202. In an embodiment, a plurality of frequency orthogonal signals are transmitted on each of the transmitting antennas 202.

When a touch object 205 approaches and comes into contact with the seat cover 201, the signal delta continuously changes in the same direction. That is to say as the touch object 205 approaches the seat cover 201 the touch delta either increases or decreases depending on the manner in which the interaction is being measured. When the seat cover 201 is deformable, and as it compresses under pressure, the touch delta changes in a manner that indicates a continuing approach.

In an embodiment, the seat cover 201 is a compressible foam, and is formed so as to compress under pressure. In an embodiment, the pressure used to compress the seat cover 201 is less than the pressure needed to compress the internal layer 206. In the embodiment shown in FIG. 2, the internal layer 206 is made of foam. However, it should be understood that internal layer 206 may be made of any material that is compressible when subjected to a weight that is characteristic of a human. Internal layer 206 may be formed of more than one sublayer of material.

As a touch object 205 contacting the seat cover 201 applies more pressure to the seat cover 201, the internal layer 206 located between transmitting antenna 202 and grounding layer 204 compresses. The compression of the internal layer 206 will bring the transmitting antenna 202 closer to the grounding layer 204. In the embodiment of FIG. 2, grounding layer 204 provides the same benefits as transmitting antenna 204 does in FIG. 1. The presence of the grounding layer 204 enables the deltas measured by the sensing system 200 to be enhanced as the transmitting antenna 202 approaches the grounding layer 204.

The substrate layer 208 is preferably made of material that deforms less than the material from which internal layer 206 is made. The deformability of the internal layer 206 with respect to the substrate layer 208 is such that the internal layer 206 deforms more than the substrate layer 208.

In an embodiment, the internal layer 206 is made of a first type of foam material that deforms more than a foam material that the substrate layer 208 is made from. In an embodiment, the internal layer 206 is made of a foam that is more deformable than a plastic material from which the substrate layer 208 is made. In an embodiment, the internal layer 206 is made of a foam that is more deformable than a metallic material from which the substrate layer 208 is made. The relationship between the internal layer 206 and the substrate layer 208 is preferably such that substrate layer 208 substantially does not, or at all, deform so that most of the deformation internally within the seat system occurs at the internal layer 206 (after compression of the seat cover 101).

By having the grounding layer 204, a much greater signal delta is measured when the internal layer 206 moves. Because the grounding layer 204 enhances the ability to measure the deltas in the signals received, the deformation of the internal layer 206 and the deltas caused by the measured signals are amplified, thereby enabling an enhanced view of deformations caused by movement of the seat system 200.

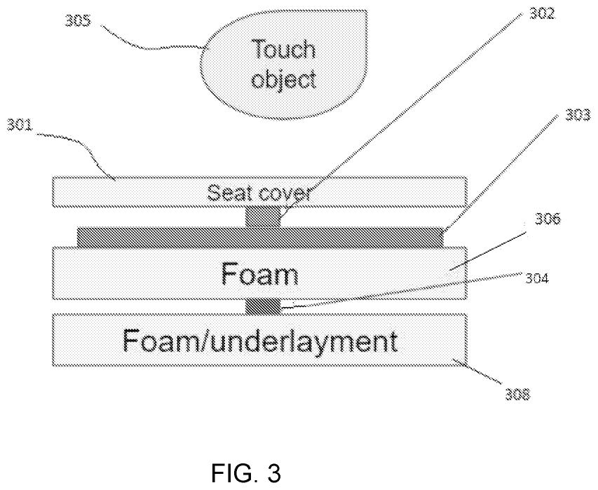

FIG. 3 shows a cross-sectional view of an embodiment of a seat system 300. Seat system 300 comprises a seat or seats used in the same manner as the above discussed seat systems 100 and 200. The functions and uses of seat systems 100 and 200 are applicable to the functions and uses of seat system 300. The seat system 300 comprises a seat cover 301. The seat cover 301 is the portion of the seat system 300 upon which an individual or an object is placed. Located under the seat cover 301 is a transmitting antenna 302, a receiving antenna 303 and a grounding line 304. In an embodiment, the transmitting antenna 302 is coplanar with the seat cover 301. In an embodiment, the transmitting antenna 302 is interwoven with the seat cover 301. In an embodiment, the receiving antenna 303 is coplanar with the seat cover 301 and interwoven with the seat cover 301 or embedded in the seat cover 301. In an embodiment, both the transmitting antenna 302 and the receiving antenna 303 are coplanar with the seat cover 301 and interwoven with the seat cover 301 or embedded in the seat cover 301.

FIG. 3 is a cross-sectional view, as such, the widthwise portion of transmitting antenna 302 is shown. In FIG. 3 the lengthwise portion of transmitting antenna 302 extends into the page. Similarly the widthwise portion of the ground line 304 is shown in FIG. 3, while the lengthwise portion of the ground line 304 extends into the page. The lengthwise cross-sectional view of the receiving antenna 303 is shown. Further, for ease of description, only one grouping of transmitting antenna 302, grounding line 304 and receiving antenna 303 is shown. It should be understood that in some embodiments there are a plurality of transmitting antennas and receiving antennas that are used in forming the seating system.

Transmitting antenna 302 is in a substantially fixed relationship with respect to the receiving antenna 303. That is to say transmitting antenna 302 does not move with respect to the receiving antenna 303 and transmitting antenna 302 and receiving antenna 303 should move as a pair. In an embodiment, the transmitting antenna and the receiving antenna are in a known relationship with respect to each other. That is to say one of or both of the receiving antenna or the transmitting antenna may move with respect to the other, but in a manner that is predetermined.

Transmitting antenna 302 is located proximate to receiving antenna 303 so that interaction with the field lines by a touch object 305 permits determination of measurements that will determine a touch event. The transmitting antenna 302 and the receiving antenna 303 are located proximate to each other and form a tixel that is adapted to pick up hover and near hover from the presence of a touch object 305. In an embodiment, the touch object 305 is a human that is to occupy the seat. When there is a plurality of transmitting antennas 302, in an embodiment, a plurality of signals that are orthogonal with respect to each other signal transmitted on the transmitting antennas are transmitted on each of the plurality of transmitting antennas 302. In an embodiment, a plurality of frequency orthogonal signals are transmitted on each of the antennas and each of the plurality of frequency orthogonal signals transmitted on each of the transmitting antennas 302 are orthogonal to each of the signals transmitted on the transmitting antenna 302 and each other signal transmitted on each other transmitting antenna 302.

When the touch object 305 approaches and comes into contact with the seat cover 301, the signal delta changes continuously in the same direction, either decreasing or increasing. That is to say as the touch object approaches the seat cover 301 the touch delta either increases or decreases depending on the manner in which the interaction is being measured. When the seat cover 301 is deformable, and as it compresses under pressure, the touch delta changes in a manner that indicates a continuing approach. In an embodiment, the seat cover 301 is typically a compressible foam, and so is formed so as to compress under minimal pressure. Preferably less than the pressure needed to compress the internal layer 306. In the embodiment shown in FIG. 3 the internal layer 306 is made of foam. However, it should be understood that internal layer 306 may be made of any material that is compressible when subjected to a weight that is characteristic of humans. Internal layer 306 may comprise one or more sublayers of material in its formation.

As the touch object 305 provides more pressure to the seat cover 301 the internal layer 306 located between transmitting antenna 302 and grounding line 304 compresses. In the embodiment of FIG. 3, grounding line 304 provides the same benefits as transmitting antenna 104 does in FIG. 1 and the grounding layer 204 does in FIG. 2. The presence of the grounding line 304 enables the deltas measured by the sensing system 300 to be enhanced and thereby facilitates the determination of the presence of the touch object 305 and the magnitude of the pressure being applied to the seat.

The substrate layer 308 is preferably made of material that deforms less than the material from which internal layer 306 is made. The deformability of the internal layer 306 with respect to the substrate layer 308 is such that the internal layer 306 deforms more than the substrate layer 308. In an embodiment, the internal layer 306 is made of a first type of foam material that deforms more than a foam material that the substrate layer 308 is made from. In an embodiment, the internal layer 306 is made of a foam that is more deformable than a plastic material from which the substrate layer 308 is made. In an embodiment, the internal layer 306 is made of a foam that is more deformable than a metallic material from which the substrate layer 308 is made. The relationship between the internal layer 306 and the substrate layer 308 is preferably such that substrate layer 308 substantially does not, or at all, deform so that most of the deformation in the seat system occurs at the internal layer 306.

By having the grounding layer 304, a much greater signal delta is caused when the internal layer 306 moves. Because the grounding layer 304 enhances the ability to measure the deltas in the signals received, the deformation of the internal layer 306 and the deltas caused by the measured signals are amplified, thereby enabling an enhanced view of deformations caused by movement of the seat system 300. Both the grounding layer 204 and the grounding line 304 changes the coupling in the negative delta direction similar to the transmitting antenna 104 that is transmitting a signal that is 180 degrees out of phase.

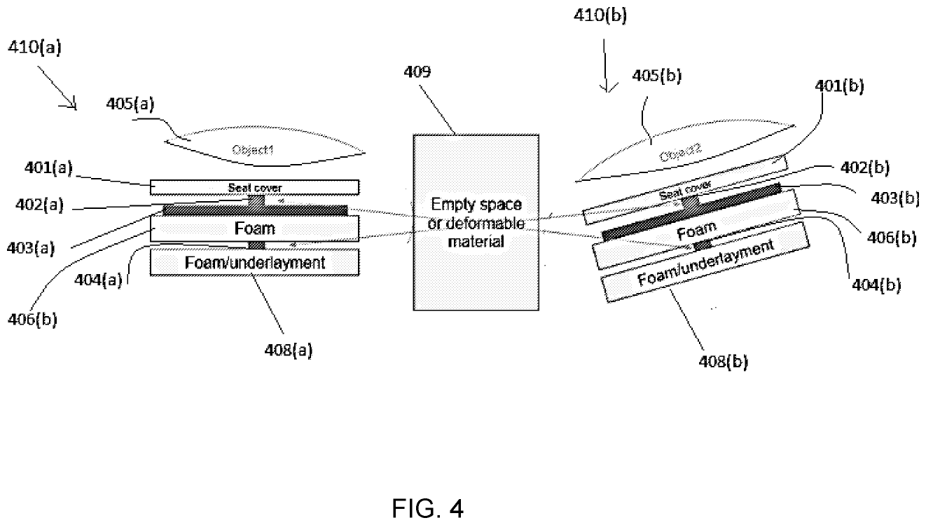

Turning now to FIG. 4, shown is a seat system 400 that is adapted to be used with any of the embodiments discussed above. In an embodiment the seat system 400 uses transmitting antennas 404(a) and 404(b) that transmit signals that are 180 degrees out of phase with respect to the signal transmitted from its respective transmitting antennas 402(a) and 402(b). In the embodiment, shown the signals transmitted from transmitting antennas 402(a) and 402(b) are orthogonal with respect to each other. In the embodiment, the signals transmitted from transmitting antennas 402(a) and 402(b) are frequency orthogonal with respect to each other. In an embodiment, the seat system 400 uses ground layers as shown in FIG. 2. In an embodiment, the seat system 400 uses ground lines as shown in FIG. 3.

In seat system 400, shown are two sensor arrangements 410(a) and 410(b) of seat covers 401(a) and 401(b), transmitting antennas 402(a) and 402(b), receiving antennas 403(a) and 403(b), transmitting antennas 404(a) and 404(b), internal layers 406(a) and 406(b) and substrate layers 408(a) and 408(b). Each of the sensor arrangements shown in FIG. 4 function in the same manner as the seat system 100 discussed above. However, each of the sensor arrangements 410(a) and 410(b) are independent of each other but also may function in a cooperative manner. The transmitting antennas 402(a) and 402(b) and the receiving antennas 403(a) and 403(b) are distinct (i.e. they do not share a common conductor). Instead of being arranged in “rows and columns” with a transmitting antenna row sharing its unique signal with all the receiving antennas that cross it, in an embodiment, each transmitting antenna and receiving antenna are operatively connected independent of each other, this provides the capability of being able to obtain multiple measurements with respect to each other.

The sensor arrangements 410(a) and 410(b) may be separated by an area 409. In an embodiment, the area 409 is space. In an embodiment, the area 409 is deformable material. In an embodiment, the area 409 is non-deformable material.

The sensor arrangements 410(a) and 410(b) are able to determine the deformation of a seat for each of their respective seats and are also able to determine movement with respect to each other. Receiving antenna 403(a) is able to take signals received and measured from transmitting antenna 402(b) and use those measurements to provide information related to the deformation or movement of the object 405(b) with respect to sensor arrangement 410(a). Likewise, receiving antenna 403(b) is able to take signals received and measured from transmitting antenna 402(a) and use those measurements to provide information related to the deformation or movement of the object 405(a) with respect to sensor arrangement 410(b). Seat system 400 can be scaled up to have multiple sensor arrangements (i.e. more than two) in order to determine multiple relationships of objects with respect to each other and groups of objects with respect to other groups of objects. The relationships that are determined can be one of position with respect to each other, one of distance with respect to each other, relative deformation of a seat by each object, overall seat capacity based on the relative deformations. In an embodiment, the relationship of each passenger in a vehicle with respect to each other passenger in a vehicle can be determined. In an embodiment, the relationship includes weight as well as position and the weight and relationship of each passenger in an airplane with respect to each other passengers on an airplane can be determined and used to properly balance a plane.

An aspect of this disclosure is a seat system. The seat system comprising: at least one transmitting antenna adapted to transmit a first signal having a frequency and a phase; at least one receiving antenna adapted to receive the signal transmitted from the at least one transmitting antenna, at least one other transmitting antenna adapted to transmit a second signal adapted to alter the measurement of the first signal received by the receiving antenna; and an internal layer located between the at least one transmitting antenna and the at least one other transmitting antenna.

Another aspect of this disclosure is a seat system comprising: at least one transmitting antenna adapted to transmit a signal having a frequency and a phase; at least one receiving antenna adapted to receive the signal transmitted from the at least one transmitting antenna, a source of signal ground adapted to alter measurement of the signal received by the receiving antenna; and an internal layer located between the at least one transmitting antenna and the source of signal ground.

Still another aspect of the disclosure is a seat system comprising: a plurality of transmitting antennas each of the plurality of transmitting antennas adapted to transmit a signal having a frequency and a phase; a plurality of receiving antennas each of the plurality of receiving antennas adapted to receive signal transmitted from at least one of the plurality of transmitting antennas; a source of signal ground adapted to alter measurement of signals received by the plurality of receiving antennas; an internal layer located between at least one of the plurality of transmitting antennas and the source of signal ground.

While the invention has been particularly shown and described with reference to a preferred embodiment thereof, it will be understood by those skilled in the art that various changes in form and details may be made therein without departing from the spirit and scope of the invention.

1. A seat system comprising:
at least one transmitting antenna adapted to transmit a first signal having a frequency and a phase;
at least one receiving antenna adapted to receive the signal transmitted from the at least one transmitting antenna,
at least one other transmitting antenna adapted to transmit a second signal adapted to alter the measurement of the first signal received by the receiving antenna; and
an internal layer located between the at least one transmitting antenna and the at least one other transmitting antenna.

2. The seat system of claim 1, further comprising a seat cover made from a deformable material, wherein the internal layer is less deformable than the seat cover.

3. The seat system of claim 1, further comprising a substrate layer, wherein the substrate layer is less deformable than the internal layer.

4. The seat system of claim 1, wherein the second signal is 180 degrees out of phase from the phase of the first signal.

5. The seat system of claim 1, wherein the second signal is adapted to alter measured signal delta of the first signal received by the receiving antenna.

6. The seat system of claim 1, wherein received signals are processed to determine information about an object's relationship to the seat system.

7. The seat system of claim 1, wherein the at least one transmitting antenna and the at least one receiving antenna are in a fixed relationship with respect to each other.

8. The seat system of claim 1, wherein the at least one receiving antenna is located between the at least one transmitting antenna and the at least one other transmitting antenna.

9. A seat system comprising:
at least one transmitting antenna adapted to transmit a signal having a frequency and a phase;
at least one receiving antenna adapted to receive the signal transmitted from the at least one transmitting antenna,
a source of signal ground adapted to alter measurement of the signal received by the receiving antenna; and
an internal layer located between the at least one transmitting antenna and the source of signal ground.

10. The seat system of claim 9, further comprising a seat cover made from a deformable material, wherein the internal layer is less deformable than the seat cover.

11. The seat system of claim 9, further comprising a substrate layer, wherein the substrate layer is less deformable than the internal layer.

12. The seat system of claim 9, wherein received signals are processed to determine information about an object's relationship to the seat system.

13. The seat system of claim 9, wherein the at least one transmitting antenna and the at least one receiving antenna are in a fixed relationship with respect to each other.

14. The seat system of claim 9, wherein the at least one receiving antenna is located between the at least one transmitting antenna and the source of signal ground.

15. The seat system of claim 9, wherein the source of signal ground is a ground line.

16. The seat system of claim 9, wherein the source of signal ground is a ground layer.

17. The seat system of claim 9, wherein the signal ground is adapted to alter measured signal delta of the signal received by the receiving antenna.

18. A seat system comprising:
a plurality of transmitting antennas each of the plurality of transmitting antennas adapted to transmit a signal having a frequency and a phase;
a plurality of receiving antennas each of the plurality of receiving antennas adapted to receive signal transmitted from at least one of the plurality of transmitting antennas;
a source of signal ground adapted to alter measurement of signals received by the plurality of receiving antennas;
an internal layer located between at least one of the plurality of transmitting antennas and the source of signal ground.

19. The seat system of claim 18, wherein each of the plurality of transmitting antennas transmit signals frequency orthogonal to each other signal transmitted.

20. The seat system of claim 18, wherein at least one of the plurality of transmitting antennas is in fixed relationship with respect to at least one of the plurality of receiving antennas.
